(19) United States
(12) Patent Application Publication
(10) Pub. No.: US 2011/0022470 A1
(43) Pub. Date: Jan. 27, 2011

(54) System and Method for Real-Time Ad Selection and Scheduling

(76) Inventors: Sridhar Varadarajan, Bangalore (IN); Amit Thawani, Bangalore (IN)

Correspondence Address: THE WEBB LAW FIRM, P.C., 700 KOPPERS BUILDING, 436 SEVENTH AVENUE, PITTSBURGH, PA, 15219, US

(21) Appl. No.: 12/506,384

(22) Filed: Jul. 21, 2009

(51) Int. Cl. G06Q 30/00

(52) U.S. Cl. 705/14.61

(57) ABSTRACT

Ads play an important role in enhancing the market reach of the products. Televisions are one of the major targets for advertising to reach mass market. With the advent of the Internet, video on demand mode of delivering content, to a variety of devices such as personal computers and mobile phones, has become a possibility. New ad targeting opportunities arise when the multitude of technologies are combined. One of the aspects of ad targeting, to keep the viewers' attention focused on ads, is to “beat the expectations.” A system and method to help in keeping viewers' attention focused on ads involves randomly selecting an ad to be displayed using a randomly selected ad display model at a randomly selected time interval during the course of watching of content. Further, a viewer's attention on ads gets enhanced when the randomly selected ads are appropriate from the point of view of the content being watched.

### FIELD OF THE INVENTION

The present invention relates to ad targeting in general, and more particularly, ad targeting when content is being watched. Still more particularly, the present invention is related to a system and method for real-time ad selection and scheduling for targeting purposes so as to enhance viewers' attention on the displayed ads.

### BACKGROUND OF THE INVENTION

Ad targeting in general and TV ad targeting in particular involves delivering specific ads to specific audience. Ad customization deals with diverse consumer segments and hundreds of variations of an ad are generated, say based on context-based business rules, to help in targeting. This further helps in making the ads more effective at the same time reducing the ad wear-out. It has been observed that many TV viewers cite having already seen a commercial, possibly several times, as one of the major reasons for their intent to skip the TV commercials. In order to help retain the interests of the users on the ads, it is required to “beat the expectations” of the viewers. This needs to be achieved while a user is viewing content on a television, personal computer, or mobile phone. Note that “user,” “viewer,” and “subscriber” are used interchangeably. Specifically, the ads compete with content in being able to draw the attention of the viewers. Further, the viewers are mentally tuned to watch the content and hence, the ads are treated an unwanted interruptions. On the other hand, the return of investment on ads is related to the attention factor: the fraction of time the user's attention is on the ads being shown. As a consequence, any solution that addresses the issues related to ad monotonicity, that is, the bombarding of the viewers with the same and most importantly predictable ads, would go a long way in improving the return on investment for the ad sponsors.

### DESCRIPTION OF RELATED ART

U.S. Pat. No. 7,228,555 to Schlack; John A. (Southampton, Pa.) for “System and method for delivering targeted advertisements using multiple presentation streams” (issued on Jun. 5, 2007 and assigned to Prime Research Alliance E., Inc. (Tortola, VG)) describes a system and method for delivering channels of presentation streams carrying targeted advertisements in a television service network environment that includes a generator for generating a set of presentation streams for each of programming channels, each of the presentation streams in each set having same programming data but different ads directed to advertiser-specific market segments of different advertisers.

U.S. Pat. No. 7,203,684 to Carobus; Alexander Paul (Mountain View, Calif.), Roetter; Alex (Palo Alto, Calif.), Davenport; Ben (Mountainview, Calif.) for “Serving content-targeted ADS in e-mail, such as e-mail newsletters” (issued on Apr. 10, 2007 and assigned to Google, Inc (Mountainview, Calif.)) describes an approach for serving content-targeted ads with emails such as email newsletters by including a unique content identifier in the content and using of the same to fetch content-relevant ads from an ad server.

U.S. Pat. No. 7,185,353 to Schlack; John A. (Southampton, Pa.) for “System and method for delivering statistically scheduled advertisements” (issued on Feb. 27, 2007 and assigned to Prime Research Alliance E., Inc. (Tortolla, VG)) describes a system and method for scheduling advertisements in a television network based on such information as channel change statistical information and avail information.

U.S. Pat. No. 6,463,585 to Hendricks; John S. (Potomac, Md.), Bonner; Alfred E. (Bethesda, Md.), McCoskey; John S. (Derwood, Md.), Asmussen; Michael L. (Herndon, Va.) for “Targeted advertisement using television delivery systems” (issued on Oct. 8, 2002 and assigned to Discovery Communications, Inc. (Bethesda, Md.)) describes a novel multiple channel architecture that is designed to allow targeted advertising directed to television terminals connected to an operations center or a cable headend by providing additional feeder channels to early alternate advertising that may be better suited for certain viewing audiences.

U.S. Pat. No. 6,144,944 to Kurtzman, II; Stephen J. (San Jose, Calif.), Nawathe; Sandeep A. (Sunnyvale, Calif.) for “Computer system for efficiently selecting and providing information” (issued on Nov. 7, 2000 and assigned to Imgis, Inc. (Cupertino, Calif.)) describes a system for selecting advertisements in response to a request from a web page server based on such information as demographic information, page sponsor information, and keyword sponsor information.

“Auctioning Ad Space in Video on Demand (VoD) Assets” by Hood; Bill, Sinha; Nishith, and Barker; Reed (document available in the URL; http://www.experts-iptv.com/database/forums2007/advertizing_methods_vodassets.pdf) describes a competitive selection of advertising for Video on Demand based on real-time and near real-time “ad auctioning” that provides a mechanism for dynamically selecting advertisements that need to be placed in conjunction with a specific viewing of a movie.

“Event Driven Semantics Based Ad Selection” by Thawani; Amit, Gopalan; Srividya, and Varadarajan; Sridhar (appeared in the Proceedings of the 2004 IEEE International Conference on Multimedia and Expo (ICME '2004), The Grand Hotel, Taipei, Taiwan, Jun. 27-30, 2004) describes a system for the selection, filtering, and presentation of advertisements based on detected program events and profiles contained in the Home Information System.

“Viewing Characteristics based Personalized Ad Streaming in an Interactive TV Environment” by Thawani; Amit, Gopalan; Srividya, and Varadarajan; Sridhar (appeared in the Proceedings of the 2004 IEEE Consumer Communications and Networking Conference, Caesar's Palace, Las Vegas, Nev., USA, Jan. 5-8, 2004 (CCNC 2004)) describes a channel surfing analysis algorithm for predicting the “user(s) in front” of a television to enable deciding about the nature of ads that are likely to have an impact.

The known systems are largely related to the selection and scheduling of ads based on sponsors' needs and in some cases accounting of relevance. And, hence, do not explicitly address the various issues related to ad monotonicity and ad wear-out. The present invention provides a system and method for the randomized selection and scheduling of ads so as to “beat the expectations” of the users thereby reducing ad monotonicity and ad wear-out.

### SUMMARY OF THE INVENTION

The primary objective of the invention is to reduce ad monotonicity and ad wear-out in the context of ads shown during the watching of a content on a television, personal computer, or mobile phone.

One aspect of the invention is to exploit multiple ad models for effective display of ads.

Another aspect of the invention is to exploit multiple ads related to the multiple ad models.

Yet another aspect of the invention is to randomly select ads.

Another aspect of the invention is to randomly distribute the randomly selected ad models throughout the content timeline.

Yet another aspect of the invention is to ensure that the randomly selected ads are relevant to the content being watched.

### BRIEF DESCRIPTION OF THE DRAWINGS

FIG. 1 depicts an overview of the System for Ad Scheduling (SAS).

FIG. 2 provides an overview of the illustrative ad models.

FIG. 3 provides an overview of Time Allocation for Ads.

FIG. 3a provides an approach for Time Allocation for Ads.

FIG. 4 provides an overview for Scheduling of Ads.

FIG. 4a provides an approach for Randomized Ad Scheduling (LbAC).

FIG. 4b provides an approach for Randomized Ad Scheduling (SbAC).

FIG. 4c provides an approach for Randomized Ad Scheduling (SAC).

### DETAILED DESCRIPTION OF THE PREFERRED EMBODIMENTS

Ads are an important component of any content delivery system. For example, consider a broadcasting scenario: in this case, the content is typically delivered onto a television sets at homes. Most of the programs aired in this manner have one or more sponsors and in return, each of the sponsors gets spots during the airing of the corresponding programs to display their ads. The major expectation on the part of sponsors is that ads, especially during prime time, lead to increased sales revenue. However, the constant bombardment of the same ads can turn out to be counterproductive: viewers may turn off television sets or may skip to another channel. It has been observed in the literature that such a behavior is partially due to the boredom of seeing the same ad again and again leading to ad wear-out. The main challenge is to make ad viewing a pleasure thereby, reducing the boredom and ad wear-out. A solution for this challenge is to identify ads, to be inserted at various time points during the delivering and displaying of a content (say, a movie), so that it is not monotonous and it “beats the expectations.”

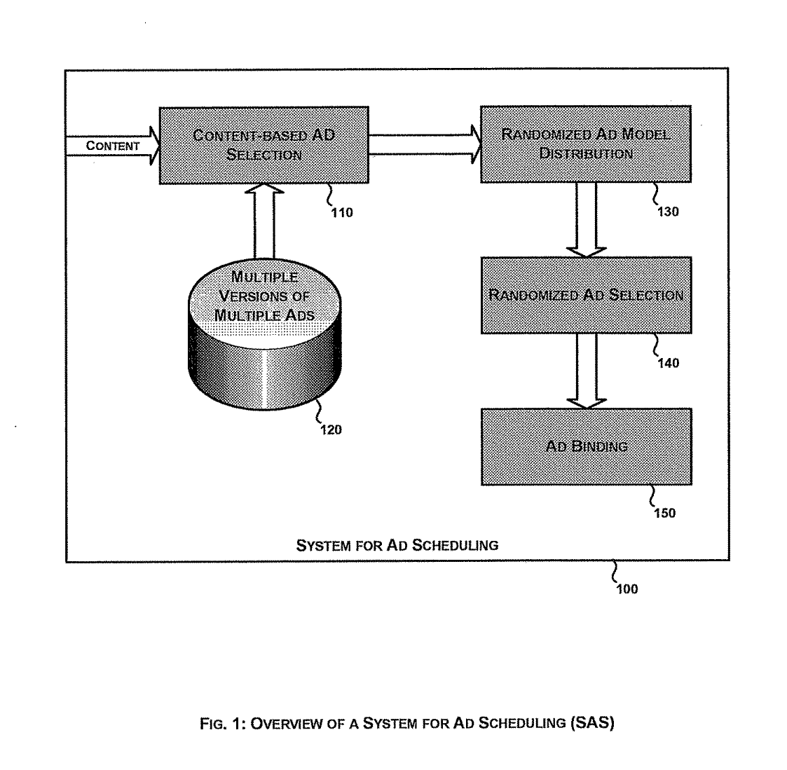

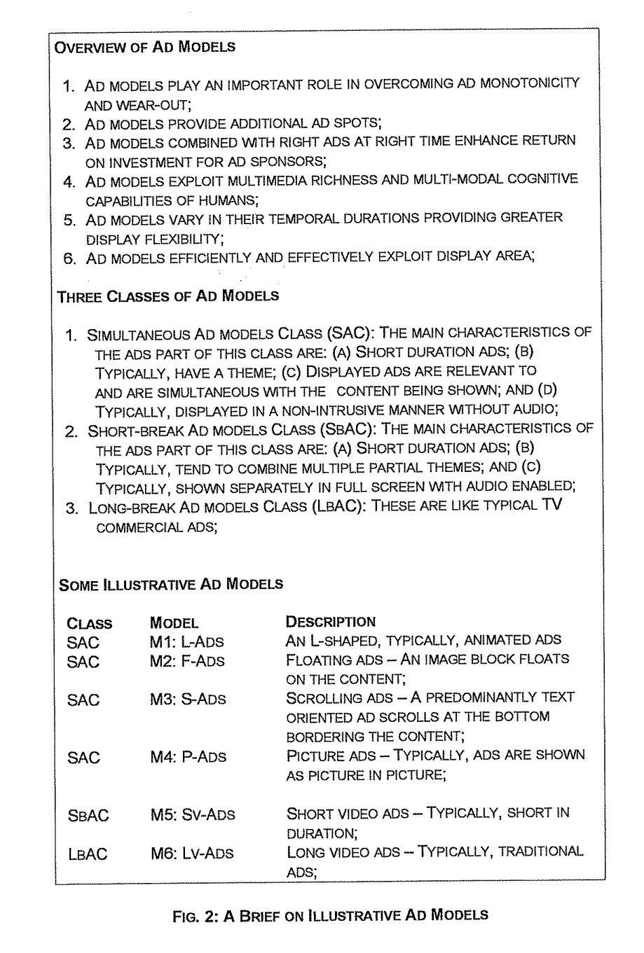

FIG. 1 depicts an overview of the System for Ad Scheduling (SAS). Given a content (say, a movie), the system (100) identifies multiple ads that are relevant to the content and a subset of these identified ads gets inserted into the content for to be shown on an end user device (say, a television). The basic idea is to use as many ad models as possible for the displaying of the ads so that there is a variety; further, the ads are randomly selected and displayed at randomly selected time points leading to a surprising package of content and ads. It is anticipated that such a surprising package overcomes the fatigue due to the watching of traditional display of ads and hence, the ads can have a positive impact on the viewers. Initially, the input content is analyzed so as to retrieve a set of content-specific ads (110) from a database containing multiple versions of multiple ads related to multiple ad models (120). In order to avoid monotonicity, the ad models are randomly selected distributed randomly throughout the viewing timeline associated with the content (130). The set of content-specific ads contains more ads than what can get inserted into the content and hence, a subset is randomly selected (140) keeping in mind the ad model distribution. Finally, the randomly selected ads are bound with the content based on the randomly distributed ad models (150) to create a surprising package of content and ads.

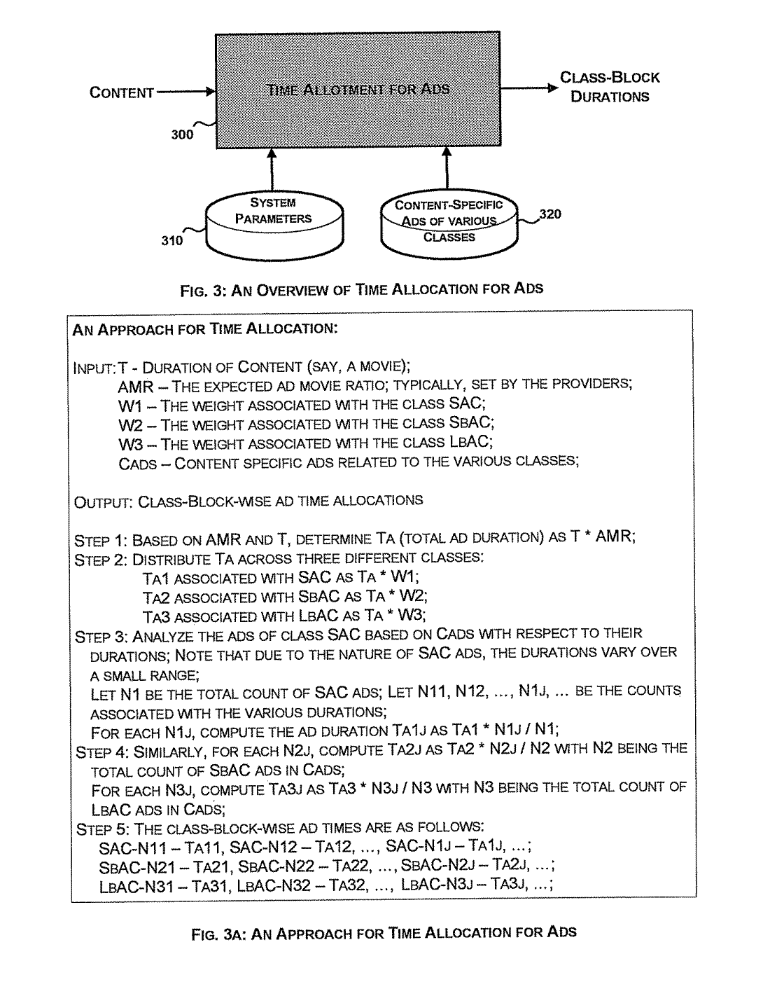

FIG. 2 provides an overview of the illustrative ad models. Ad models describe the varied ways in which ads can be displayed on an end user device. A brief overview of Ad Models is as follows:
1. Ad models play an important role in overcoming ad monotonicity and wear-out;
2. Ad models provide additional ad spots;
3. Ad models combined with right ads at right time enhance return on investment for ad sponsors;
4. Ad models exploit multimedia richness and multi-modal cognitive capabilities of humans;
5. Ad models vary in their temporal durations providing greater display flexibility;
6. Ad models efficiently and effectively exploit display area;

For illustrative purposes, three classes of ad models are identified.
1. Simultaneous Ad models Class (SAC): The main characteristics of the ads part of this class are: (a) Short duration ads; (b) Typically, have a theme; (c) Displayed ads are relevant to and are simultaneous with the content being shown; and (d) Typically, displayed in a non-intrusive manner without audio.
2. Short-break Ad models Class (SbAC): The main characteristics of the ads part of this class are: (a) Short duration ads; (b) Typically, tend to combine multiple partial themes; and (c) Typically, shown separately in full screen with audio enabled.
3. Long-break Ad models Class (LbAC): These are like typical TV commercial ads.

Some Illustrative Ad Models are as follows:

| Class | Model | Description |
|---|---|---|
| SAC | M1: L-Ads | An L-shaped, typically, animated ads |
| SAC | M2: F-Ads | Floating ads - An image block floats on the |
| | | content; |
| SAC | M3: S-Ads | Scrolling ads - A predominantly text oriented ad |
| | | scrolls at the bottom bordering the content; |
| SAC | M4: P-Ads | Picture ads - Typically, ads are shown as picture |
| | | in picture; |
| SbAC | M5: Sv-Ads | Short video ads - Typically, short in duration; |
| LbAC | M6: Lv-Ads | Long video ads - Typically, traditional ads; |

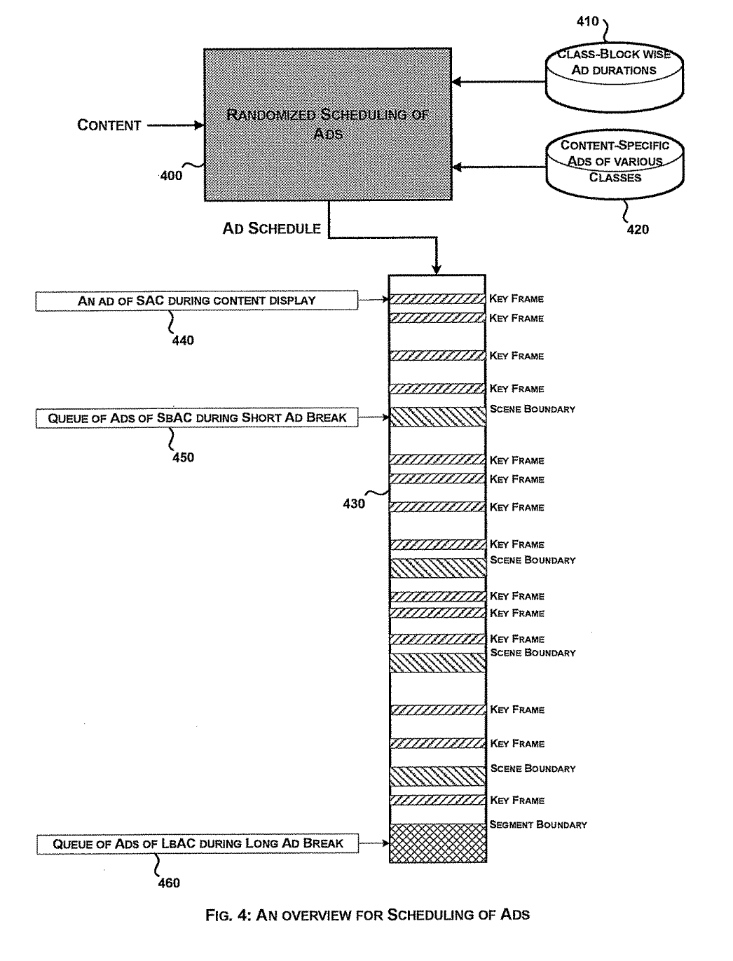

FIG. 3 provides an overview of Time Allocation for Ads. There are a variety of ad models and each of these ad models forms part of a class. Keeping in mind the ad monotonicity and ad wear-out, it is required to allocate time of display for the various ads (300). In order to have more flexibility in ad randomization, the time allotment is undertaken at class level. That is, total ad durations are allotted for the various of the classes such as SAC, SbAC, and LbAC. For a given content, the appropriate system parameters (310) are obtained. Also, obtained are the content-specific ads related to the various classes (320). Based on these inputs, ad time is allotted for each of the classes and each block of each of these classes. Here, a block is a group of ads of a class, say, based on the duration of the ads.

FIG. 3a provides an approach for Time Allocation for Ads.

### An Approach for Time Allocation:

Input: T—Duration of Content (say, a movie);
AMR—The expected ad movie ratio; typically, set by the providers;
W1—The weight associated with the class SAC;
W2—The weight associated with the class SbAC;
W3—The weight associated with the class LbAC;
Cads—Content specific ads related to the various classes;

Here, AMR stands for Ad to Movie Ratio. This is one of the operator/provider controlled parameters and indicates the amount of possible ad time while delivering a particular content, say a movie. Typically, it is a value between 0 and 1. Operator/provider also specifies how the ads related to the various of the classes need to be prioritized. One way to specify this information is to define a weight for each class such that the sum of the weights is unity. For example, for each of the three classes, a weight is associated as follows: W1 with SAC, W2 with SbAC, and W3 with LbAC with W1+W2+W3=1;

### Output: Class-Block-Wise Ad Time Allocations

Step 1: Based on AMR and T, determine Ta (total ad duration) as T*AMR;
Step 2: Distribute Ta across three different classes:
   Ta1 associated with SAC as Ta*W1;
   Ta2 associated with SbAC as Ta*W2;
   Ta3 associated with LbAC as Ta*W3;
Step 3: Analyze the ads of class SAC based on Cads with respect to their durations; Note that due to the nature of SAC ads, the durations vary over a small range; Let N1 be the total count of SAC ads; Let N11, N12, . . . , N1j, . . . be the counts associated with the various durations;
   For each N1j, compute the ad duration Ta1j as Ta1*N1j/N1;
Step 4: Similarly, for each N2j, compute Ta2j as Ta2*N2j/N2 with N2 being the total count of SbAC ads in Cads;
   For each N3j, compute Ta3j as Ta3*N3j/N3 with N3 being the total count of LbAC ads in Cads;
Step 5: The class-block-wise ad times are as follows:
   SAC-N11-Ta11, SAC-N12-Ta12, . . . , SAC-N1j-Ta1j, . . . ;
   SbAC-N21-Ta21, SbAC-N22-Ta22, . . . , SbAC-N2j-Ta2j, . . . ;
   LbAC-N31-Ta31, LbAC-N32-Ta32, . . . , LbAC-N3j-Ta3j, . . . ;

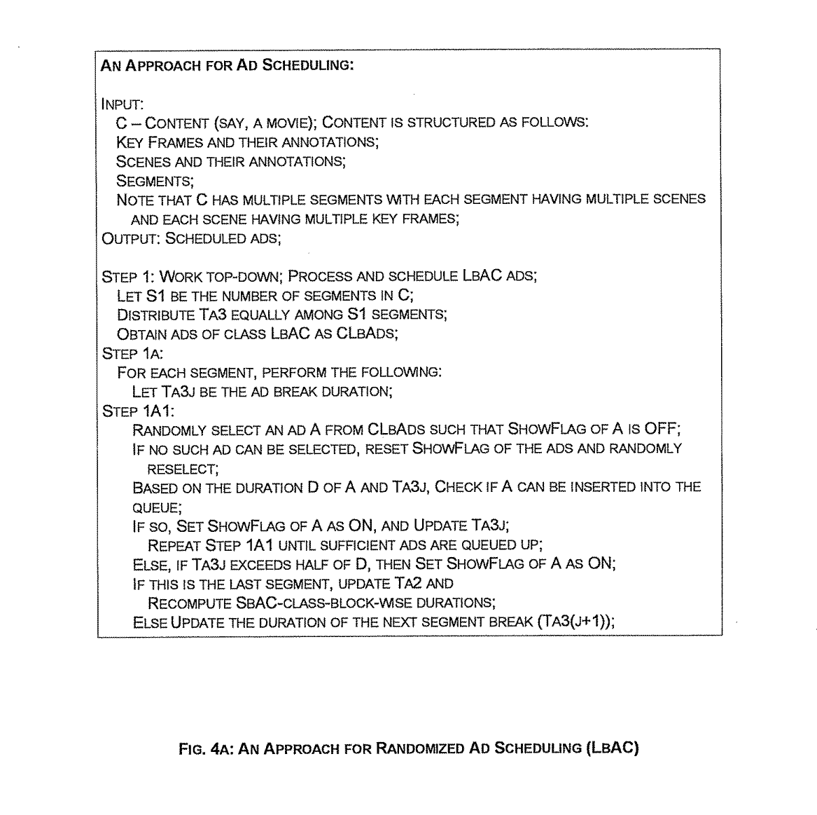

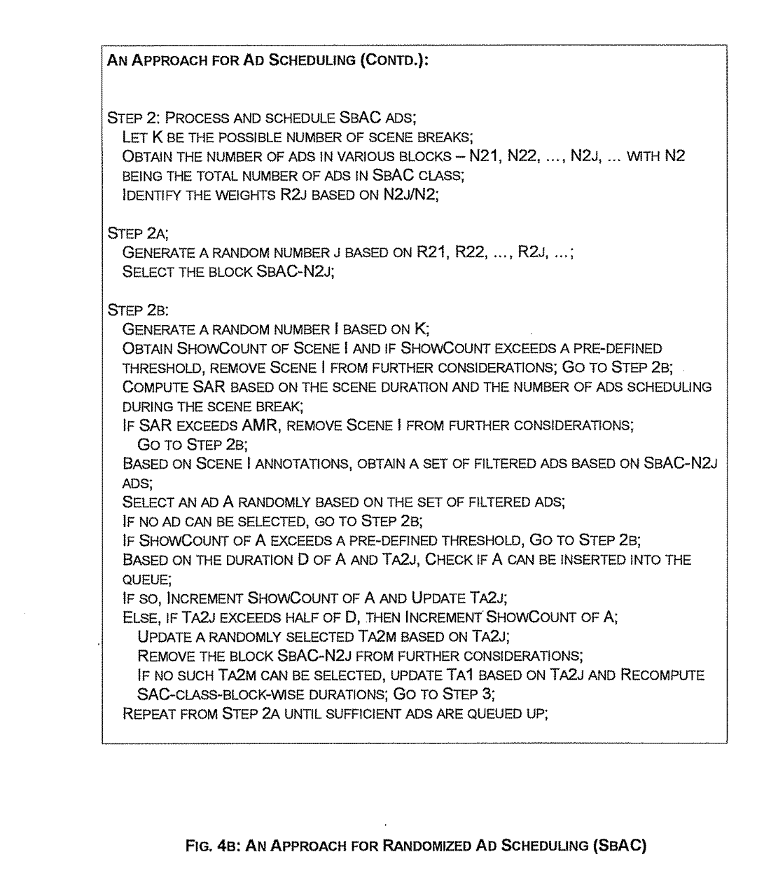

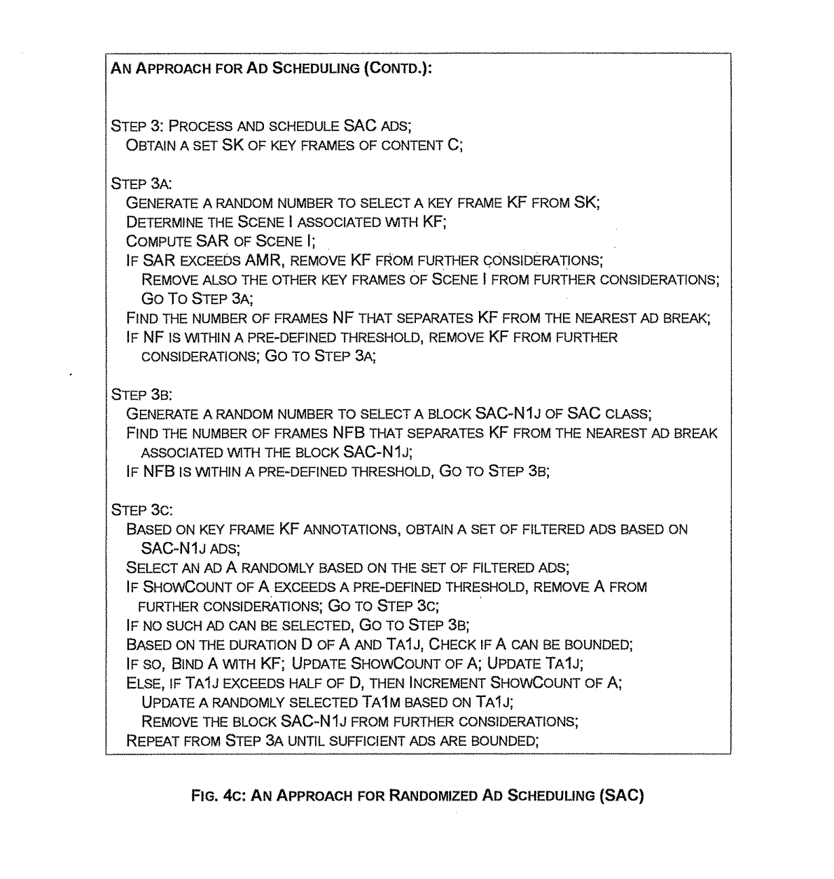

FIG. 4 provides an overview for Scheduling of Ads. The randomized scheduling of ads (400) takes content for which ads are being scheduled as input along with class-block-wise ad time durations (410) and the content-specific ads of the various classes (420) to generate randomized ad schedules. 430 depicts a portion of content with scheduled ads. Note that in one of the embodiments, SAC class ads are simultaneous while SbAC and LbAC class ads are shown during a break. As a consequence, in the case of scheduling of ads related to SAC class, initially, a model is selected randomly and a randomly selected ad based on the selected ad model is bound with the content. On the other hand, in the case of SbAC or LbAC class, an ad is selected randomly and queued up to be displayed during the break. For the purposes of ad binding, the content is viewed as a structure comprising of multiple segments, with each segment comprising multiple scenes, and finally, with each scene comprising multiple key frames. 440 depicts a scheduling of an ad of SAC class. Note that “scheduling of ads” and “binding of ads” are used interchangeably. Note that SAC class ads are bound with respect to an anchor key frame. That is, the ad gets displayed either starting at key frame or the key frame appears at about half way during the simultaneous displaying of the ad. SbAC class ads are scheduled during a break following a randomly selected scene (450). And, finally, LbAC class ads are scheduled at the end of a segment (460).

FIG. 4a provides an approach for Randomized Ad Scheduling (LbAC). Ads of the various classes are scheduled based on the allotted durations: Ta1 for SAC class, Tat for SbAC class, and Ta3 for LbAC class.

An Approach for Ad Scheduling for ads of LbAC class is as follows:

### Input:

C—Content (say, a movie); Content is structured as follows:
Key Frames and their annotations;
Scenes and their annotations;
Segments;
Note that C has multiple segments with each segment having multiple scenes and each scene having multiple key frames;
   Output: Scheduled ads;
   Step 1: Work top-down; Process and schedule LbAC ads;
Let S1 be the number of segments in C;
Distribute Ta3 equally among S1 segments;
Obtain ads of class LbAC as CLbAds;

### Step 1a:

For each segment, perform the following:
   Let Ta3j be the ad break duration;

### Step 1a1:

Randomly select an ad A from CLbAds such that ShowFlag of A is OFF;
If no such ad can be selected, reset ShowFlag of the ads and randomly reselect;
Based on the duration D of A and Ta3j, Check if A can be inserted into the queue;
If so, Set ShowFlag of A as ON, and Update Ta3j;
   Repeat Step 1a1 until sufficient ads are queued up;
Else, if Ta3j exceeds half of D, then Set ShowFlag of A as ON;
If this is the last segment, update Tat and Recompute SbAC-class-block-wise durations;
Else Update the duration of the next segment break (Ta3(j+1));

Note that the ads are randomly selected so as to create a surprise in viewer's mind. Further, all the ads in the class are given an opportunity to be selected before reconsidering an ad again for scheduling.

FIG. 4b provides an approach for Randomized Ad Scheduling (SbAC). Having scheduled LbAC ads, the next step is to schedule SbAC ads. In this embodiment description, while no block-wise randomized selection is described in the case of LbAC class ads, the selection of SbAC ads illustrates block-wise randomized selection.

An Approach for Ad Scheduling (Contd.):

Step 2: Process and schedule SbAC ads;
Let K be the possible number of scene breaks;
Obtain the number of ads in various blocks—N21, N22, . . . , N2j, with N2 being the total number of ads in SbAC class;
Identify the weights R2j based on N2j/N2;

### Step 2a;

Generate a random number j based on R21, R22, . . . , R2j, . . . ;
Select the block SbAC-N2j;

### Step 2b:

Generate a random number I based on K;
Obtain ShowCount of Scene I and if ShowCount exceeds a pre-defined threshold, remove Scene I from further considerations; Go to Step 2b;
Compute SAR based on the scene duration and the number of ads scheduling during the scene break;
If SAR exceeds AMR, remove Scene I from further considerations;
   Go to Step 2b;
Based on Scene I annotations obtain a set of filtered ads based on SbAC-N2j ads;
Select an ad A randomly based on the set of filtered ads;
If no ad can be selected, go to Step 2b;
If ShowCount of A exceeds a pre-defined threshold, Go to Step 2b;
Based on the duration D of A and Ta2j, Check if A can be inserted into the queue;
If so, Increment ShowCount of A and Update Ta2j;
Else, if Ta2j exceeds half of D, then Increment ShowCount of A;
   Update a randomly selected Ta2m based on Ta2j;
   Remove the block SbAC-N2j from further considerations;
   If no such Ta2m can be selected, update Ta1 based on Ta2j and Recompute SAC-class-block-wise durations; Go to Step 3;
Repeat from Step 2a until sufficient ads are queued up;

Note that SAR stands for Scene Ad Ratio which is used in conjunction with AMR, the Ad Movie Ration. SAR of a scene describes the ratio of the amount of ads that has been inserted for to be displayed during the scene break, and the scene duration.

FIG. 4c provides an approach for Randomized Ad Scheduling (SAC).

The final step is to schedule SAC ads.

An Approach for Ad Scheduling (Contd.):

Step 3: Process and schedule SAC ads;
Obtain a set SK of key frames of content C;

### Step 3a:

Generate a random number to select a key frame KF from SK;
Determine the Scene I associated with KF;
Compute SAR of Scene I;
If SAR exceeds AMR, remove KF from further considerations;
   Remove also the other key frames of Scene I from further considerations;
   Go To Step 3a;
Find the number of frames NF that separates KF from the nearest ad break;
If NF is within a pre-defined threshold, remove KF from further considerations; Go to Step 3a;

### Step 3b:

Generate a random number to select a block SAC-N1j of SAC class;
Find the number of frames NFB that separates KF from the nearest ad break associated with the block SAC-N1j;
If NFB is within a pre-defined threshold, Go to Step 3b;

### Step 3e:

Based on key frame KF annotations, obtain a set of filtered ads based on SAC-N1j ads;
Select an ad A randomly based on the set of filtered ads;
If ShowCount of A exceeds a pre-defined threshold, remove A from further considerations; Go to Step 3c;
If no such ad can be selected, Go to Step 3b;
Based on the duration D of A and Ta1j, Check WA can be bounded;
If so, Bind A with KF; Update ShowCount of A; Update Talk
Else, if Ta1j exceeds half of D, then Increment ShowCount of A;
   Update a randomly selected Ta1m based on Ta1j;
   Remove the block SAC-N1j from further considerations;
Repeat from Step 3a until sufficient ads are bounded;

Thus, a system and method for randomized ad selection and scheduling is disclosed.

Although the present invention has been described particularly with reference to the figures, it will be apparent to one of the ordinary skill in the art that the present invention may appear in any number of systems that need to overcome monotonicity and package a deliverable that “beats the expectations.” It is further contemplated that many changes and modifications may be made by one of ordinary skill in the art without departing from the spirit and scope of the present invention.

What is claimed is:

1. A method for overcoming ad monotonicity and ad wear-out in the context of delivering a surprise package of a content along with a plurality of content-specific scheduled ads, wherein each of said plurality of content-specific scheduled ads is a part of a plurality of content-specific ads, each of said plurality of content-specific ads is a part of a plurality of ads, and said content comprises a plurality of segments, a plurality of scenes, and a plurality of key frames, wherein said method comprising:
obtaining of a class of each of said plurality of ads, wherein said class is one of a simultaneous ad models class, a short break ad models class, or a long break ad models class;
obtaining of a plurality of segment scenes associated with each of segment of said plurality of segments;
obtaining of a plurality of scene key frames associated with each scene of said plurality of scenes;
obtaining of a plurality of scene annotations, wherein each of said plurality of scene annotations is associated with a scene of said plurality of scenes;
obtaining of a plurality of key frame annotations, wherein each of said plurality of key frame annotations is associated with a key frame of said plurality of key frames;
obtaining of an ad movie ratio associated with said content;
obtaining of a weight 1 associated with said simultaneous ad models class;
obtaining of a weight 2 associated with said short break ad models class;
obtaining of a weight 3 associated with said long break ad models class;
determining of a plurality of simultaneous ad models ads based on said plurality of content-specific ads, wherein the class of each of said plurality of simultaneous ad models ads is said simultaneous ad models class;
determining of a plurality of short break ad models ads based on said plurality of content-specific ads, wherein the class of each of said plurality of short break ad models ads is said short break ad models class;
determining of a plurality of long break ad models ads based on said plurality of content-specific ads, wherein the class of each of said plurality of long ad models ads is said long break ad models class;
determining of a plurality of simultaneous ad models class blocks based on said plurality of simultaneous ad models ads and duration of each of said plurality of simultaneous ad models ads;
determining of a plurality of short break ad models class blocks based on said plurality of short break ad models ads and duration of each of said plurality of short break ad models ads;
determining of a plurality of long break ad models class blocks based on said plurality of long break ad models ads and duration of each of said plurality of long break ad models ads;
allotting of ad time for each of said simultaneous ad models class blocks, each of said short break ad models class blocks, and each of said long break ad models class blocks resulting in a total simultaneous ad models class duration, a plurality of simultaneous ad models class block ad durations, a total short break ad models class duration, a plurality of short break ad models class block ad durations, a total long break ad models class duration, and a plurality of long break ad models class block ad durations;
randomly binding of a plurality of segment ads during segment ad break at the end of each of said plurality of segments, wherein each of said plurality of segment ads is a part of said content-specific scheduled ads;
randomly binding of a plurality of scene ads during scene break at the end of each of a plurality of randomly selected scenes based on said plurality of scenes, wherein each of said plurality of scene ads is a part of said content-specific scheduled ads; and
randomly binding of a plurality of key frame ads with a plurality of randomly selected key frames based on said plurality of key frames for displaying of said plurality of key frame ads during the displaying of said randomly selected key frames, wherein each of said plurality of key frame ads is a part of said content-specific scheduled ads.

2. The method of claim 1, wherein said method of allotting further comprising:
obtaining of a duration of said content;
computing of a total ad duration based on said duration and said ad movie ratio;
computing of said total simultaneous ad models class duration based on said total ad duration and said weight 1;
computing of said total short break ad models class duration based on said total ad duration and said weight 2;
computing of said total long break ad models class duration based on said total ad duration and said weight 3;
computing of a simultaneous ad models class count based on said plurality of simultaneous ad models ads;
computing of a short break ad models class count based on said plurality of short break ad models ads;
computing of a long break ad models class count based on said plurality long break ad models ads;
computing of a plurality of simultaneous ad models class block counts based on said plurality simultaneous ad models class blocks;
computing of a plurality of short break ad models class block counts based on said plurality short break ad models class blocks;
computing of a plurality of long break ad models class block counts based on said plurality long break ad models class blocks;
determining of a simultaneous ad models class block ad duration of said plurality of simultaneous ad models class block ad durations based on a count of said plurality of simultaneous ad models class block counts, said total simultaneous ad models class duration, and said simultaneous ad models class count;
determining of a short break ad models class block ad duration of said plurality of short break ad models class block ad durations based on a count of said plurality of short break ad models class block counts, said total short break ad models class duration, and said short break ad models class count; and
determining of a long break ad models class block ad duration of said plurality of long break ad models class block ad durations based on a count of said plurality of long break ad models class block counts, said total long break ad models class duration, and said long break ad models class count.

3. The method of claim 1, wherein said method of randomly binding of said plurality of segment ads further comprising:
determining of a total number of segments in said plurality of segments;
computing of a plurality of segment ad durations based on said total number of segments and said total long break ad models class duration;
obtaining of said plurality of long break ad models ads;
obtaining of a segment of said plurality of segments;
obtaining of a segment ad duration of said segment based on said plurality of segment ad durations;
randomly selecting of an ad from said plurality of long break ad models ads, wherein the number of times said ad is selected is less than a pre-defined threshold;
obtaining of a duration of said ad;
checking of whether said ad is appropriate based on said duration and said segment ad duration;
inserting of said ad into said plurality of segment ads associated with said segment;
updating of said segment ad duration;
selecting of a neighboring segment of said plurality of segments;
updating of a neighboring segmentation ad duration of said plurality of segment ad durations, wherein said neighboring segment ad duration is associated with said neighboring segment; and
updating of said total short break ad models class duration and said plurality of short break ad models class block ad durations.

4. The method of claim 1, wherein said method of randomly binding of said plurality of scene ads further comprising:
determining of a total number of scene breaks based on said plurality of scenes;
determining of a total number of ads in said plurality of short break ad models ads;
determining of a plurality of number of ads based on said plurality of short break ad models class blocks;
determining of a plurality of weights based on said plurality of number of ads and said total number of ads;
randomly generating of a random block number based on said plurality of weights;
selecting of a block based on said random block number and said plurality of short break ad models class blocks;
obtaining of a block duration of said block based on said plurality of short break ad models class block ad durations;
randomly generating of a random scene based on said total number of scene breaks, wherein the number of times said random scene is selected is less than a pre-defined threshold;
obtaining of a scene duration of said random scene;
obtaining of a plurality of ads associated with the scene break of said random scene;
computing of a scene ad ratio based on said scene duration and a plurality of durations associated with said plurality of ads, wherein said scene ad ratio is within said ad movie ratio;
obtaining of a scene annotation of said random scene based on said plurality of scene annotations;
obtaining of a plurality of block ads based on said plurality short break ad models class blocks and said random block number;
determining of a plurality of filtered ads based on said plurality of block ads and said scene annotation;
randomly selecting of an ad from said plurality of filtered ads, wherein the number of selections of said ad is less than a pre-defined threshold;
obtaining of an ad duration of said ad;
checking of whether said ad is appropriate based on said ad duration and said block duration;
updating of said block duration;
making of said random scene a part of said plurality of randomly selected scenes;
inserting of said ad into said plurality of scene ads associated with said random scene;
updating of a randomly selected short break ad models class block ad duration of said plurality of short break ad models class block ad durations; and
updating of said total simultaneous ad models class duration and said plurality of simultaneous ad models class block ad durations.

5. The method of claim 1, wherein said method of randomly binding of said plurality of key frame ads further comprising:
obtaining of said plurality of key frames;
randomly selecting of a key frame from said plurality of key frames;
obtaining of a scene of said plurality of scenes, wherein said key frame is associated with said scene;
computing of a scene ad ratio of said scene, wherein said scene ad ratio is within said ad movie ratio;
computing of a distance between said key frame and a nearest ad associated with said content, wherein said distance is measured in number of frames and said distance exceeds a pre-defined threshold;
generating of a random block number;
selecting of a block based on said random block number and said plurality of simultaneous ad models class blocks;
obtaining of a block duration of said block based on said plurality of simultaneous ad models class block ad durations;
computing of a distance between said key frame and a nearest ad associated with said content, wherein said distance is measured in number of frames, said nearest ad is associated with said block, and said distance exceeds a pre-defined threshold;
obtaining of a key frame annotation of said key frame based on said plurality of key frame annotations;
obtaining of a plurality of block ads based on said plurality simultaneous ad models class blocks and said block;
determining of a plurality of filtered ads based on said plurality of block ads and said key frame annotation;
randomly selecting of an ad from said plurality of filtered ads, wherein the number of selections of said ad is less than a pre-defined threshold;
obtaining of an ad duration of said ad;
checking of whether said ad is appropriate based on said ad duration and said block duration;
updating of said block duration;
making of said key frame a part of said plurality of randomly selected key frames;
inserting of said ad into said plurality of key frame ads; and
updating of a randomly selected simultaneous ad models class block ad duration of said plurality of simultaneous ad models class block ad durations.
